(19) United States
(12) Patent Application Publication
(10) Pub. No.: US 2015/0348452 A1
(43) Pub. Date: Dec. 3, 2015

(54) BALLOON-BASED, HIGH ALTITUDE, LONG RANGE NOTIFICATON SYSTEM

(71) Applicants: Ryan Bendremer, Sherborn, MA (US); Owen Bingham, Sherborn, MA (US); Nate Randa, Sherborn, MA (US); Sam Randa, Sherborn, MA (US); Dillon Natale, Sherborn, MA (US); Zachary Szeto, Sherborn, MA (US)

(72) Inventors: Ryan Bendremer, Sherborn, MA (US); Owen Bingham, Sherborn, MA (US); Nate Randa, Sherborn, MA (US); Sam Randa, Sherborn, MA (US); Dillon Natale, Sherborn, MA (US); Zachary Szeto, Sherborn, MA (US)

(21) Appl. No.: 14/714,630

(22) Filed: May 18, 2015

Related U.S. Application Data
(60) Provisional application No. 62/003,576, filed on May 28, 2014.

(51) Int. Cl. G09F 7/20; G09F 23/00; F16M 13/02

(52) U.S. Cl. CPC G09F 7/20; F16M 13/02; G09F 23/00; G09F 2007/1856

(57) ABSTRACT

A balloon-based long range notification apparatus comprises an elevating object capable of lifting up in air. A tether is coupled to a portion of the elevating object on one end thereof and to an object on another end thereof for anchoring the elevating object. A means for holding a display article to the tether is provided. The display article has means thereon for providing a visual indication.

### CROSS REFERENCE TO RELATED APPLICATIONS

This Patent Application is a non-provisional utility application which claims the benefit under 35 U.S.C. §119(e) from U.S. Provisional Patent Application No. 62/003,576 filed on May 28, 2014, entitled, “BALLOON-BASED, HIGH ALTITUDE, LONG RANGE NOTIFICATION SYSTEM”, the contents and teachings of which are herein incorporated by this reference in their entirety.

### BACKGROUND

1. Technical Field

This application relates to a field, which comprises the art for a balloon-based long range notification system.

2. Description of Related Art

A natural disaster occurs when forces of nature damage communities or put many people in danger. Natural disasters of all kinds happen in every part of the world. Each year almost 250 million people find themselves in or near a natural disaster. Examples of natural disasters include fire, flood, power loss, snow storms, hurricanes or tornados. Natural disasters such as tornadoes, hurricanes and other extreme weather formations can quickly become devastating events that cause widespread property damage, power outages and life threatening situations for people.

Disaster may be of man-made origin as well, for example transportation accidents, acts of war and terrorism. One common denominator in all of these events is a need to provide help to victims in as timely and effective manner possible under the circumstances.

When a natural or manmade disaster occurs, many people often find themselves without resources, without adequate transportation and infrastructure, and/or even without homes. Emergency responders try to help victims as best as they can. However, victims of natural or manmade disasters do not always receive all of the assistance they require. For example, a person who is a victim of a disaster may be in need of food, medical supplies, and/or shelter. However, either directing victims of a disaster to a location where aid or assistance may be available or providing assistance to victims of a disaster is not always possible when communication and transportation infrastructure is compromised in a disaster area.

Further, natural disasters including hurricanes, tornados, floods, and wildfires injure and kill thousands in the United States. Though not common in the U.S., tsunamis and earthquakes pose similar threats elsewhere around the world. The devastating effects of natural disasters are not limited to immediate injuries to people in the direct path of the natural disasters. Rather, damage to critical infrastructure, emergency supplies, and the like impacts the effective response of rescue workers and emergency responders. For example, water supplies may become contaminated due to floods. Hospitals may be destroyed, preventing the treatment of otherwise routine injuries. Disease may spread. And blocked roads, collapsed bridges, and the like prevent the effective movement of resources such as relief supplies from one place to another. Thus, there is a real and dire risk that many people in disaster areas will suffer new injuries, face further problems, or even die while rescue workers struggle to help them. Communication is critical in this respect.

As technology has evolved, emergency response organizations have started to increasingly depend on communication technology (such as wired phones, wireless cellphones) to provide communication during emergencies. Thus, ordinarily, the provision of supplies and services is accomplished through a complex communication and information network. In disaster areas, there is a heightened need for the efficient delivery of supplies and services, particularly medical supplies and food. During disaster situations, emergency responders rely on such communication. For example, a working telephone connection may be required. Thus, the reliance on communication devices such as mobile devices and their supporting networks has led to vulnerability in the event of a disaster or other event disrupting network communications. In addition, communication means of notifying the public such as radio, television, and Internet are dependent on various layers of infrastructure. When a disaster strikes, damage frequently is done to the critical communication and information infrastructure, challenging both the provision of supplies and the coordination of relief efforts. Traditional communication methods typically are unable to withstand the force of nature, or they are simply rendered inoperable. For example, tornadoes can knock over power lines, telephone poles, earthquakes can destroy cell/radio/television towers, and hurricanes can impact satellite transmitters and/or receivers. In the event of such a disruption of network services during a disaster, victims of the disaster may be unable to utilize traditional communication networks and services to communicate with emergency authorities, family, or friends.

In the event of natural and/or manmade disasters and other emergencies, time may be of the essence to deliver food, medicine, or other critical items to people in need of help. For example, it might be essential to provide water to people cut off from a clean water supply in the event of flooding, an earthquake, and/or a hurricane.

Moreover, during emergency situations, there may not be any kind of two way communication available. Thus, in such emergency situations, there may not be an adequate way of attracting assistance. People have built signal fires, waved flags or arms to attract attention to their plight. The problem is that these methods of attracting help require that the person involved in the emergency situation repeatedly perform an act of doing something. Action required may be continual broadcasting of a “help needed” message or of attracting attention. However, persons involved in an emergency situation may not be physically able to devote the time and energy to attract emergency assistance.

Thus, it will be appreciated that there exists a need in the art for a method and/or system for enabling a notification system when a disaster is detected and/or realized, at least to serve as a tool for assisting emergency responders to coordinate relief efforts.

Therefore there is a need for a method and apparatus for notifying victims of a disaster where help may be available for an emergency situation that is not subject to one or more limitations of the prior art. Consequently, there is a need to notify availability of help to individuals for a disaster situation that is not dependent upon real-time access to existing communications infrastructure.

### SUMMARY OF THE INVENTION

A balloon-based long range notification apparatus comprises an elevating object capable of lifting up in air. A tether is coupled to a portion of the elevating object on one end thereof and to an object on another end thereof for anchoring the elevating object. A means for holding a display article to the tether is provided. The display article has means thereon for providing a visual indication.

### BRIEF DESCRIPTION OF THE DRAWINGS

Features and advantages of the present invention will become more apparent from the following detailed description of exemplary embodiments thereof taken in conjunction with the accompanying drawings in which:

FIG. 1 is a perspective view of a notification apparatus according to the current invention described herein.

### DETAILED DESCRIPTION OF EMBODIMENT(S)

Described below is a method and apparatus for use in balloon-based long range notification system, which method and apparatus may be used to provide, among other things, an elevating object capable of lifting up in air, a tether coupled to a portion of the elevating object on one end thereof and to an object on another end thereof for anchoring the elevating object, and a means for holding a display article to the tether, the display article having means thereon for providing a visual indication.

Conventionally, providing information regarding a location where help map be available to a population under emergency conditions may be an extremely difficult undertaking. Typically, power, transportation and communication infrastructures get disrupted, for example, by natural or manmade disasters. Conventionally, it is often difficult or impossible to communicate with a population of an area impacted by a disaster to inform the population of a location at which relief supplies may be available because roads may be destroyed and/or access points may be blocked, and communication infrastructure such as telephones, cell phones, radio, and television may be impacted and/or destroyed during the disaster. Consequently, in such a situation triggered by a disaster, notifying victims of a disaster about a location of relief or providing help to the victims of the disaster using conventional techniques is difficult or impossible.

It has been discovered that a cost-effective apparatus may be created to notify victims of a disaster regarding the location of disaster relief aid for distribution of supplies to large numbers of people with a minimized risk of damage to other compromised structures on the ground, to the supplies themselves, and with minimal risk of harm to people, all the while maximizing the receipt of supplies to those in need.

The current invention provides a method and an apparatus for notifying a location of relief supplies with a minimal effort on the behalf of a person involved in an emergency situation. The person in distress need only visually locate a balloon attached to a sign indicating availability of disaster aid relief in and around the area impacted by a disaster.

Further, the current invention provides a notification system that provides help to a population impacted by a disaster such that victims of the disaster may receive relief supplies and get access to a shelter. Further, such a notification system described in the current invention could be used in nearly every location and after and/or during different kinds of disaster situations.

In at least one embodiment of the current invention, the use of an inflatable marker or balloon secured to a structure such as a tent is described. Once a balloon containing a gas lighter than the air rises above the ground, it need only attach or tie to some nearby solid object resting on the ground by using a tether line. When an inflated balloon floats high above the ground, it makes a conspicuous mark for notifying the location of the structure such as a tent where disaster relief supplies may be available to victims of a disaster. Further, a balloon-based apparatus inflated by a gas such as pressurized helium may include a sign including a symbol for RED CROSS which is universally known as a disaster aid relief symbol. Thus, a balloon-based high altitude long range notification apparatus disclosed in this reference is used for notifying people indicating where to find disaster aid when local and communication infrastructure such as power, telecommunications, and roads are impacted and/or destroyed by a disaster.

Thus, the current invention relates to an emergency relief signaling device and more specifically to a signal balloon that may be inflated and released into the atmosphere with a tethering line connected thereto.

However, it should be noted that the current invention may be used for any purpose other than providing emergency relief aid such as advertising, providing information at a gathering such as a fair, indicating location of a specific facility such as a restroom at a large outdoor venue and so on.

Thus, the current invention may be used by emergency responders to provide a visual indication of a location at which help may be available to victims of a disaster. Further, the current invention may also be used by a victim of a disaster to indicate to emergency responders and/or public a visual indication of a location at which the victim may require help.

Further, the current invention may also be used by a person and/or organization to provide a visual indication of information such as indicating the location of food, information, tickets, and bathroom. Further, the current invention may also be used for commercial purposes such as advertising, marketing, notification of a sale, and providing location of an open house.

The above summary is provided merely for purposes of summarizing some example embodiments of the invention so as to provide a basic understanding of some aspects of the invention. Accordingly, it will be appreciated that the above described example embodiments are merely examples and should not be construed to narrow the scope or spirit of the invention in any way. It will be appreciated that the scope of the invention encompasses many potential embodiments, some of which will be further described below, in addition to those summarized herein.

Some example embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein.

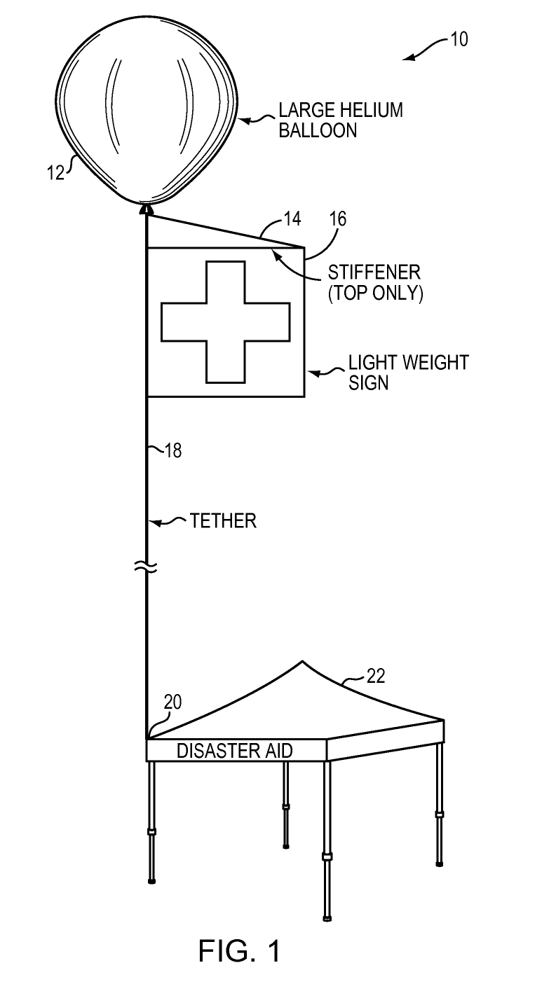

Referring now to FIG. 1, shown is an example of a balloon-based notification apparatus that may be used in connection with the current invention described herein. It should be noted that the figures are not necessarily drawn to size or scale and the proportion may be distorted.

Referring back to FIG. 1, the numeral 10 generally designates a disaster relief notification apparatus. The apparatus 10 is shown with an object capable of lifting in the air (also referred to herein as “elevated object”) component 12 (also referred to herein as an “elevated object”), in this case a balloon, that includes an adjustable securing display article 16 fastened to a tether 18 mounted in a holder 20 of a structure 22 affixed to or resting upon the ground. The disaster relief notification apparatus 10 may be easily mounted onto the ground. Once mounted, the apparatus 10 remains securely in place. Elevated object 12 used in the apparatus 10 may include, but are not limited to a balloon. Further, tether 18 may be tied to a permanent or heavy object 22 affixed to or resting upon the ground to secure the balloon.

FIG. 1 also illustrates a fastening means to maintain contact and stability of the display article 16 bearing a disaster relief sign with the tether 18 in a perpendicular fashion. Further, one end of the tethering line 18 may be secured to the mouth of the balloon 12 and the other end secured to structure 22 that may be used for providing help to victims of a disaster. The structure 22 may be secured to the ground via stakes or any other means for effectively securing the structure. The structure may include a tent, a rock, a building, a school, or any object on the ground that may enable an elevated object such as a balloon to float at a high altitude in the atmosphere which may be visually spotted by population in need of help.

In at least one preferred embodiment of the current invention, the notification apparatus 10 includes a display article 16 containing indicia (also referred to herein as a sign) indicative of a disaster relief supply such as water, food, fuel, symbols indicating shelter, food, medical supplies and so on. The indicia may include a colored material, letter, word, or a symbol to indicate the contents thereof. Thus, for example, the display article 16 may be imprinted with words such as WATER, FUEL, and FOOD. For example, blue indicium may indicate that relief aid available for victims of a disaster is water, RED CROSS indicium may indicate that relief aid available for victims of a disaster includes medical supplies, and the like. The indicia may also include instructions in a plurality of languages or graphical instructions for the nature of help provided to victims of a disaster and to indicate the use of the supplies provided for helping the victims of the disaster.

In at least one preferred embodiment of the current invention, the size of the elevated object component 12 such as a balloon may be adjusted based upon criteria such as including but not limited to the maximum height to which the balloon may rise or elevate into the air, and the weight of the display article 16 fastened to the balloon 12 using fastening means such as stiffener 14. Thus, for example, in one embodiment, the size of the balloon may be about 5 foot in diameter giving a gross lift of roughly 4 pounds to the balloon when the balloon is elevated in the air. Further, stiffener 14 provides rigidity to the display article 16 against the bending or folding of the display article 16.

Further, in at least one preferred embodiment of the current invention, the size of the display article 16 may be changed based on criteria such as the distance from which a sign on the display article may need to be visible to victims of a disaster. Thus, for example, display article 16 fastened to a balloon that is about 5 foot in diameter may be visible from the distance of up to one mile. Further, the size of letters or symbol used to create a sign on the display article 16 may be selected based on criteria such as the distance at which the sign may need to be visually readable by victims of a disaster. Thus, for example, display article measuring 5 feet in width bearing a sign of RED CROSS may be visible from the distance of up to a half mile.

Further, in at least one preferred embodiment of the current invention, the material used for display article 16 may be of varying degree of weight and strength such as vinyl, cloth, canvas, and Tyvek® banners. Tyvek® is a brand of flash-spun high-density polyethylene fibers, a synthetic material which is water resistant light-weight. Further, the top portion of the display article 16 may be fastened to tether 18 using fastening means such as a Kevlar® string. Kevlar® is a synthetic fiber of high tensile strength used as a reinforcing agent in the manufacture of materials such as tires and other rubber products and protective gear such as helmets and vests.

Further, tether 18 used to secure balloon 12 with a structure 22 affixed to or resting on the ground may be of different length based on criteria such as the size of the balloon 12, the height at which the balloon 12 may elevate into the air, and strength of the structure 22. For example, the tether 18 may be 100 feet or more in length and may be created from material such as Kevlar®.

Thus, for example, in at least one preferred embodiment, display article 16 containing the indicia of RED CROSS may be securely fastened to a balloon inflated with helium which can be visually seen from a long distance by people in need of disaster relief aid from a disaster. In at least one preferred embodiment of the current invention, the notification apparatus 10 may be created using reusable materials which may be inexpensive to purchase. Further, the notification apparatus 10 is portable in nature and may easily be setup at any location suitable for providing disaster relief aid to victims of a disaster. Further, unlike conventional methods of communication that may require use of power or local communications infrastructure, the notification apparatus 10 does not require a power source to operate and is not dependent upon any local communication infrastructure such as telephone lines and mobile devices. In at least one preferred embodiment of the current invention, the notification apparatus 10 may operate at any location suitable for distributing disaster relief aid and may be setup after and/or during different kinds of disaster situations have occurred.

Further, in at least one embodiment of the current invention, the notification apparatus 10 may be placed by emergency responders in compliance with Federal Aviation Administration (“FAA”) regulations which may include notifying an air traffic control unit of an airport in vicinity of the notification apparatus when the notification apparatus is deployed for providing help in a disaster situation.

In at least one embodiment of the current invention, an emergency signal balloon apparatus is simple to transport by car or carried by emergency responders and further easily and quickly deployed in case of a disaster or emergency. The indicia on the display article 16 such as a banner bearing the symbol of RED CROSS may be visible from the ground by virtue of the specific type of color (e.g., bright red, bright orange, iridescent color) of the balloon and from the air by virtue of the highly reflective surfaces on its outer membrane.

In at least one embodiment of the current invention, the notification apparatus 10 acts as a clear visible signal for help or assistance. The apparatus 10 has a signal balloon which is tethered by a long light-weight, high strength string such as Kevlar®. The balloon itself may be constructed of ultralight high-strength material, such as Mylar, which will be capable of holding helium gas. The signal balloon may be made of material having specific type of color, such as bright red or bright orange which is clearly visible to anyone passing by.

In the detailed description described herein, a plurality of specific details, such as types of materials and dimensions, are set forth in order to provide a thorough understanding of the preferred embodiments discussed above. The details discussed in connection with the preferred embodiments should not be understood to limit the present inventions. Furthermore, for ease of understanding, certain method steps are delineated as separate steps; however, these steps should not be construed as necessarily distinct nor order dependent in their performance.

Even though the focus has been primarily on notification of location of disaster relief aid, it is to be understood that the apparatus 10 may be used for other purposes, including but not limited to, providing various types of communications by using different messages on a display article, by using a balloon as a location marker by a victim to call for help. Such modifications may comprise removal of adjustable securing mechanism or placement of different messages on a display article attached to a tether.

Thus, the apparatus 10 may be used to provide information to the public in such a way that the information is easily identifiable from a distance. For example, the apparatus 10 may be used to provide information at an outdoor venue to the public regarding a location at which services such as food, information, tickets, and restrooms may be located. Further, the apparatus 10 may be used for commercial purposes such as during a sale or an open house of a building such as a house.

While the apparatus 10 could be made in a wide variety of ways without losing the purpose or intent, the figure do not encompass all possible means and manners. The illustrations are meant to be an example, but not limit the diverse methods of manufacturing and usage. For example, it is understood that the size, shape, and material of the apparatus may be varied according to the intended use and availability of supplies used to make the apparatus. For instance, the display article may be secured to the tether using stiffener and may also include the use of swivel snap hooks and carabineers. The shape of the display article may be varied to accommodate the insertion of a wider range of indicia. Furthermore, the apparatus may be altered in order to allow for a greater variety of uses, and to accommodate a wider range of user size and abilities.

Further, in at least one embodiment of the current technique, the display article 16 may be interchangeable in such a way that display articles including different indicia maybe used at different times based on a situation. Thus, for example, emergency responders may have a kit with different signs such that the emergency responders may use a specific sign based on the type of aid provided by the emergency responders. However, it should be noted that interchangeable display article may be used not only in emergency situations but also in non-emergency situation for different purposes.

Thus, with respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

While the invention has been disclosed in connection with preferred embodiments shown and described in detail, their modifications and improvements thereon will become readily apparent to those skilled in the art. Accordingly, the spirit and scope of the present invention should be limited only by the following claims.

What is claimed is:

1. A balloon-based long range notification apparatus comprising:
an elevating object capable of lifting up in air;
a tether coupled to a portion of the elevating object on one end thereof and to an object on another end thereof for anchoring the elevating object; and
a means for holding a display article to the tether, the display article having means thereon for providing a visual indication.

2. The apparatus of claim 1, wherein the visual indication is provided for indicating a location of a relief aid for a disaster.

3. The apparatus of claim 1, wherein the visual indication is indicative of information provided to public.

4. The apparatus of claim 1, wherein the visual indication is indicative of an advertising message.

5. The apparatus of claim 1, wherein the elevating object is a balloon, wherein the balloon is filled with a gas lighter than air.

6. The apparatus of claim 5, wherein the tether is coupled to a neck portion of the balloon inflated with helium.

7. The apparatus of claim 1, wherein the balloon-based long range notification apparatus is used in a disaster, wherein the disaster is a tropical cyclone, an earthquake, a hurricane, a tornado, a flood, a tsunami, a winter storm, a wildfire, and an emergency situation.

8. The apparatus of claim 1, wherein the balloon-based long range notification apparatus is used by a victim of a disaster to indicate a location at which the victim requires help.

9. The apparatus of claim 1, wherein the elevating object is lifted up in the air upon detecting a disaster or the possibility of a natural disaster.

10. The apparatus of claim 1, wherein the color of the elevated object is indicative of the type of relief aid available at the location at which the elevated object is lifted up in the air.

11. The apparatus of claim 1, wherein the display article includes a set of symbols, wherein a symbol is indicative of RED CROSS organization.

12. The apparatus of claim 1, wherein the display article includes a set of letters, wherein the set of letters is indicative of a purpose for which the visual indication is provided at the location at which the elevated object is lifted up in the air.

13. The apparatus of claim 1, wherein the display article is held perpendicularly to the tether by using a stiffener.

14. The apparatus of claim 1, wherein the display article is comprised of Tyvek®.

15. The apparatus of claim 1, wherein the tether is comprised of a Kevlar® string.

16. The apparatus of claim 1, wherein the elevated object and display article are visually identified from a distance of at least one half of a mile.

17. The apparatus of claim 1, wherein the tether is at least 100 feet in length.

18. The apparatus of claim 1, wherein the balloon-based long range notification apparatus is transported by an emergency responder, wherein the emergency responder places the balloon-based long range notification apparatus at a location at which relief aid is provided upon occurrence of a disaster.

19. A method for use in balloon-based long range notification, the method comprising:
lifting up an elevating object in air;
anchoring the elevating object to an object by using a tether coupled to a portion of the elevating object on one end thereof and to an object on another end thereof; and
providing a visual indication by using a display article affixed to the tether.

20. The method of claim 19, wherein the visual indication is provided for indicating a location of a relief aid for a disaster.

21. The method of claim 19, wherein the visual indication is indicative of information provided to public.

22. The method of claim 19, wherein the visual indication is indicative of an advertising message.

23. The method of claim 19, wherein the elevating object is a balloon, wherein the balloon is filled with a gas lighter than air.

24. The method of claim 23, wherein the tether is coupled to a neck portion of the balloon inflated with helium.

25. The method of claim 19, further comprising:
removing the display article; and
affixing another display article to the tether.

26. The method of claim 19, wherein the display article includes a set of symbols, wherein a symbol is indicative of RED CROSS organization.

27. The method of claim 19, wherein the display article includes a set of letters, wherein the set of letters is indicative of a purpose for which the visual indication is provided at the location at which the elevated object is lifted up in the air.
